(19) United States
(12) Patent Application Publication
(10) Pub. No.: US 2014/0007050 A1
(43) Pub. Date: Jan. 2, 2014

(54) INTERACTIVE DEVELOPMENT AND TESTING MESSAGE MODELS

(71) Applicant: International Business Machines Corporation, Armonk, NY (US)

(72) Inventors: Ella Belisario, Boca Raton, FL (US); Shane Cartledge, Markham (CA); Stephen Hanson, Hants (GB); Suman K. Kalia, Markham (CA); Timothy Kimber, Hampshire (GB); Anders S. Rawlins, Toronto (CA)

(21) Appl. No.: 13/919,029

(22) Filed: Jun. 17, 2013

Related U.S. Application Data
(63) Continuation of application No. 13/534,746, filed on Jun. 27, 2012.

(51) Int. Cl. G06F 9/44

(52) U.S. Cl. CPC G06F 8/33
USPC 717/113

(57) ABSTRACT

Developing and testing of message models includes receiving elements within a first side of an editor pane via a user interface. The elements define a logical structure of data for a message model. The development and testing also includes displaying a listing of physical properties applicable to the elements in a second side of the editor pane, and providing a movable bar between the first side of the editor pane and the second side of the editor pane. The development and testing further includes receiving a property from the listing of physical properties and associating the physical property with a corresponding one of the elements, such that selection of the element on the first side of the editor pane causes the property associated with the element to be displayed on the second side of the editor pane. The message model is created from received elements and associated physical properties.

### CROSS-REFERENCE TO RELATED APPLICATIONS

This application is a continuation of U.S. patent application Ser. No. 13/534,746, filed Jun. 27, 2012 the entire contents of each of which are incorporated herein by reference.

### BACKGROUND

The present invention relates to software development and, more particularly, to interactive development and testing of message models having non-XML data.

Developing and testing message models having non-XML data and which are used in Enterprise Service Bus (ESB) architecture involve a time-consuming, cumbersome, and error-prone process. For example, a developer first models the messages followed by deployment of the messages to a runtime environment. The developer then develops and deploys a skeleton test message flow that invokes a parser and checks the runtime trace logs if the message did not parse and/or had validation errors. From the trace logs, the developer determines potential problems in the model, updates the model using a message editor, and repeats the above process in an iterative fashion until the message model is satisfactory.

### SUMMARY

According to an embodiment of the present invention, a method for implementing interactive development and testing of message models is provided. The method includes receiving, by an editor module executing on a computer processor, elements within a first side of an editor pane via a user interface. The elements define a logical structure of data for a message model. The method also includes displaying, by the editor module, a listing of physical properties applicable to the elements in a second side of the editor pane, and providing a movable bar between the first side of the editor pane and the second side of the editor pane. The movable bar enables extended views of either of the first side and the second side of the editor pane. The method further includes receiving, by the editor module, a property from the listing of physical properties and associating the physical property with a corresponding one of the elements, such that selection of the element on the first side of the editor pane causes the property associated with the element to be displayed on the second side of the editor pane. The method also includes creating the message model from received elements and associated physical properties.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 a block diagram of a system for implementing interactive development and testing of message models according to an embodiment;

FIG. 2 depicts a flow diagram of a process for implementing interactive development and testing of message models according to an embodiment;

FIG. 3 depicts a user interface screen used in implementing the interactive development and testing of message models according to an embodiment;

FIG. 4 depicts a detailed portion of the user interface screen of FIG. 3 according to an embodiment;

FIG. 5 depicts another detailed portion of the user interface screen of FIG. 3 according to an embodiment;

FIG. 6 depicts a further detailed portion of the user interface screen of FIG. 3 according to an embodiment;

FIG. 7 depicts yet another detailed portion of the user interface screen of FIG. 3 according to an embodiment; and

FIG. 8 depicts another detailed portion of the user interface screen of FIG. 3 according to an embodiment.

### DETAILED DESCRIPTION

Exemplary embodiments relate to interactive development and testing of message models, which provides an interactive development, test, and debug of messaging models for non-XML data using a standards-based modeling language for non-XML data (e.g., binary data, text data, or a combination thereof), such as Data Format Description Language (DFDL). DFDL is a standard used for modeling non-XML data using XML schema that defines the logical structure of data and a set of annotations on schema that describe how the logical structure is transformed into a physical structure and vice versa. The exemplary interactive development and testing of message models provides a facility to describe a logical structure of data and its physical representation (DFDL) properties, a parser to parse a physical stream of data to create a logical instance, a serializer to render the logical structure to the physical stream, and a set of interlinked views to enable a user to quickly visualize and analyze the model and the parsed/serialized data from different aspects. These and other features, of the interactive development and testing of message models will now be described in an exemplary embodiment.

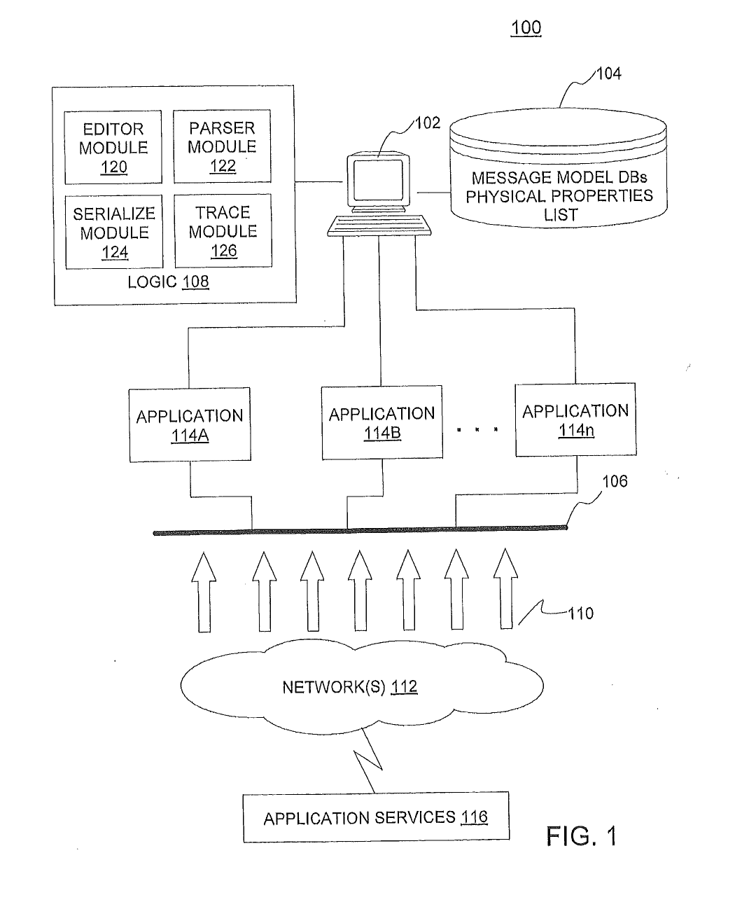

Turning now to FIG. 1, a system 100 upon which the exemplary interactive development and testing of message models may be implemented will now be described. The system 100 of FIG. 1 includes a computer 102 in communication with application services 116 over one or more networks 112. In an embodiment, the computer operates via an Enterprise Service Bus (ESB) software architectural model in a Service-Oriented Architecture (SOA). In particular, the computer 102 may be one of many computers executing various business applications, such as applications 114A-114n that send messages to an ESB 106, and the messages are processed (e.g., transformed into a format that can be interpreted by another application) through the ESB 106 and disseminated to other applications in the system 100 that may need them. Likewise, the ESB 106 receives messages 110 from application services 116 over the networks 112 for processing and disseminating. Messages 110 and services 116 are well-understood in the art of SOA.

The computer 102 may be implemented as a general-purpose computer, laptop, or host-attached terminal. Alternatively, the computer 102 may be a mainframe computer or server capable of handling a large volume of activities conducted by an enterprise or organization implementing the computer 102. The computer 102 includes processing circuits and I/O interfaces, such as a keyboard, a display device and network interface. The computer 102 can include various computer hardware and software technology known in the art, such as one or more processing units or circuits, volatile and non-volatile memory including removable media, power supplies, network interfaces, support circuitry, operating systems, and the like.

The applications 114A-114n may include any of various applications typically found in a business enterprise or organization. In an exemplary embodiment, the computer 102 also executes logic 108 for implementing interactive development, test, and debug functions for DFDL-based models, as described herein. In particular, the logic 108 includes an editor module 120, a parser module 122, a serialize module 124, and a trace module 126. The logic 108 is configured to include an interface that enables authorized individuals to perform these functions.

The computer 102 in communicatively coupled to a storage device 104. It is understood that the storage device 104 may be implemented using memory contained in the computer 102 or may be a separate physical device. In an embodiment, the storage device 104 stores message model databases and other information, as will be described further herein.

The networks 112 may be any type of known networks including, but not limited to, a wide area network (WAN), a local area network (LAN), a global network (e.g. Internet), a virtual private network (VPN), and an intranet. The networks 112 may be implemented using a wireless network or any kind of physical network implementation known in the art, e.g., using cellular, satellite, and/or terrestrial network technologies.

As described above, the exemplary interactive development and testing of message models provide an interactive development, test, and debug of messaging models for non-XML data using a standards-based modeling language for non-XML data (e.g., binary data, text data, or a combination thereof), such as Data Format Description Language (DFDL).

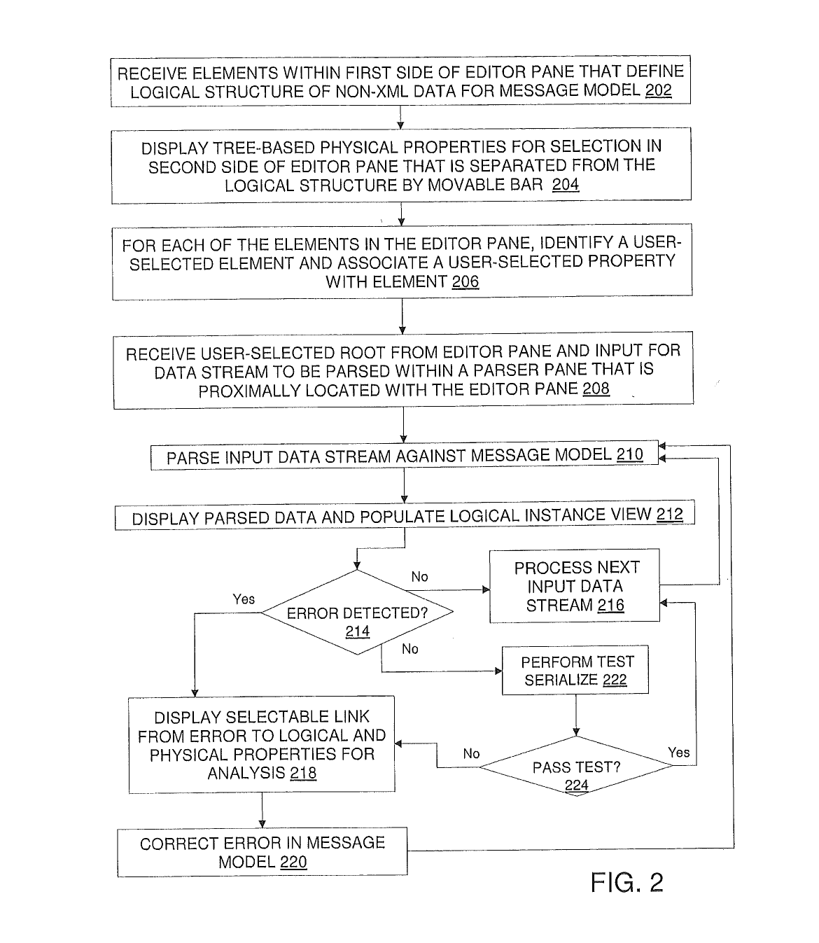

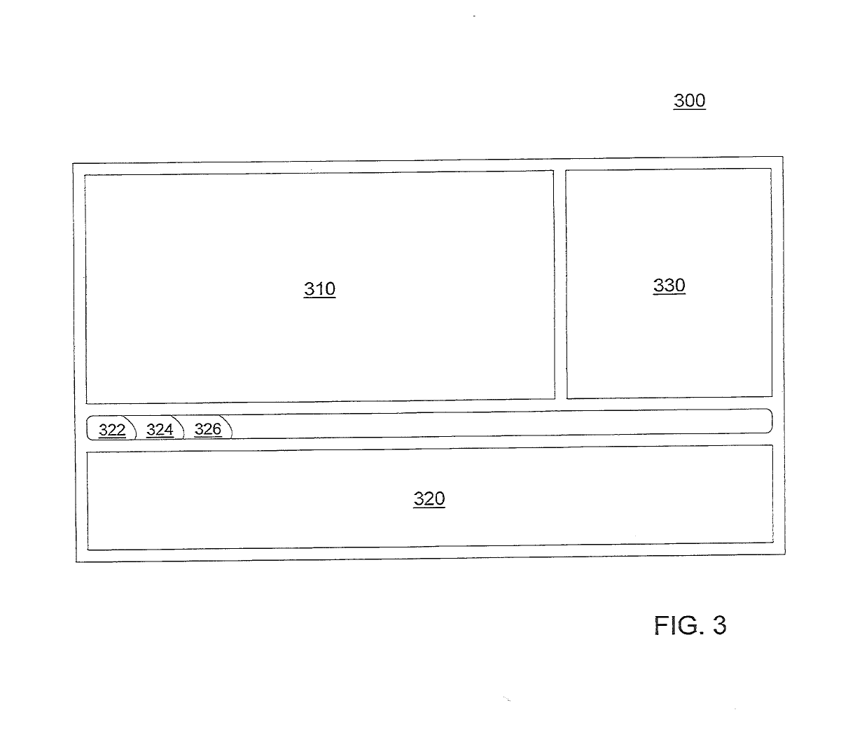

Turning now to FIG. 2, a process for implementing the interactive development and testing of message models will now be described in an exemplary embodiment. The processes described in FIG. 2 assume that a user (e.g., an application developer) has accessed the logic 108 via the computer 102 to create, debug, and test a message model having non-XML data, and the logic 108 has provided a user interface screen in response. A sample user interface screen 300 is shown in FIG. 3. The user interface screen 300 provides integrated views of various aspects and stages of a message model, as described herein.

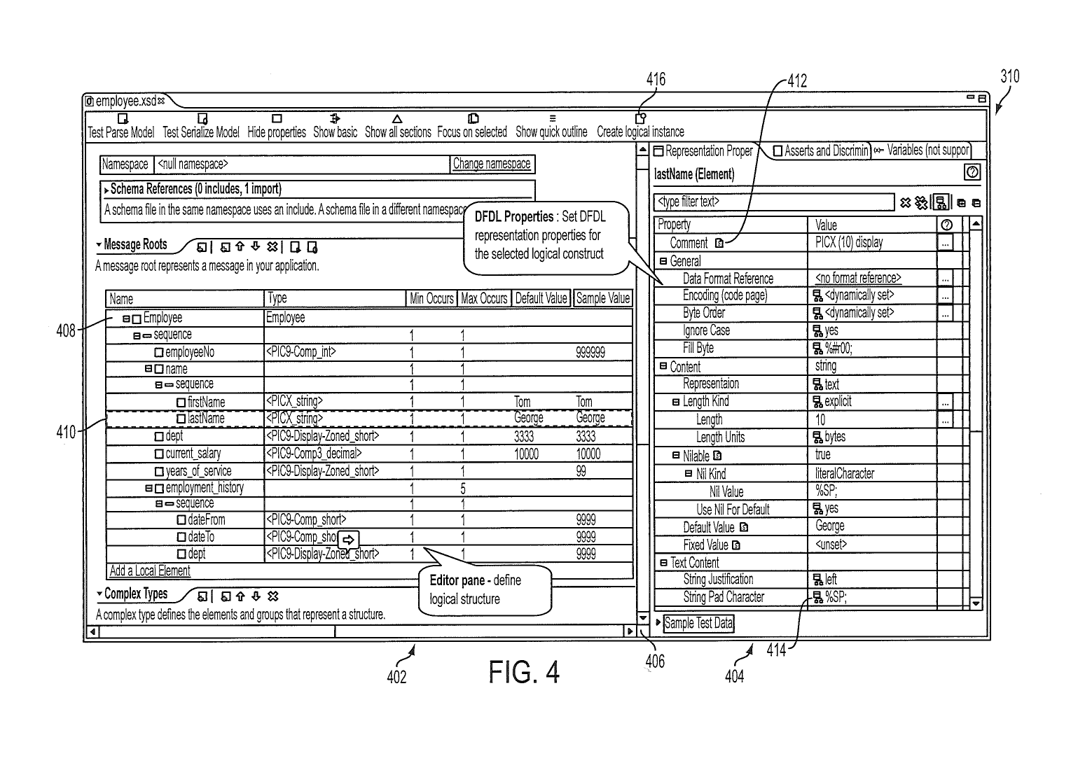

At step 202, the editor module 120 receives user-entered objects defining a logical structure of a message model. The objects are entered by the user within a first side of an editor pane 310. As shown in FIG. 4, the editor pane 310 includes a first side 402 and a second side 404. The second side 404 is separated from the first side 402 by a movable bar 406. The movable bar 406 enables the user to maximize or minimize the views of either sides 402 and 404 of the editor pane 310. As shown in FIG. 4, the first side 402 of the editor pane is to the left of the user's computer screen, and the second side 404 is to the right of the user's computer screen.

The logical structure of the message model forms a hierarchical tree structure, as illustrated in FIG. 4. The logical structure includes a root node 408 with dependent nodes (and optionally nested dependent nodes) below the root node 408. Objects defined may include elements, complex types, simple types, and groups. The logical model is created using intuitive operations provided by the editor module 120, such as “Create Document Root,” “Create Local element,” “Create Local Complex Element,” “Add Sequence,” “Add Choice,” etc. The elements entered by the user are stored in a message model database in storage device 104.

At step 204, the editor module 120 displays a listing of physical properties on the second side 404 of the editor pane 310. These physical properties describe the physical representation of the data using DFDL properties. The physical properties listing may be stored in a database in the storage device 104.

For each of the user-selected elements in the first side 402, the editor module 120 receives one or more physical properties from the listing of physical properties displayed on the second side 404 of the editor pane 310 at step 206. The editor module 120 identifies each user-selected element and associates it with a corresponding user-selected property. The user-selected elements are stored in the message model database and are linked to the corresponding physical properties, e.g., via a key or other linking technique. Communication between the two sides 402 and 404 of the editor pane 310 is based on selection events initiated from the first side 402 of the editor pane 310, and editor command stack updates that can originate from either side (first side 402 or second side 404) of the editor pane 310.

The result of these associations between logical model structure elements and the physical properties is the message model. As shown in FIGS. 3 and 4, an integrated view of both the logical structure and its physical properties is provided within a single pane 310, such that the user does not need to access an alternate view for each of the logical structure and the physical properties. Thus, the properties view shows a consolidated logical model (with schema properties illustrated by an icon 412) and the physical representation properties described through DFDL annotation.

DFDL has complex scoping rules that describe how the value of a property on an object can be obtained from the type of the object, a format object that is currently in scope, a known default value, or can be set locally on the object itself. The property view provides a convenient way of visualizing the scoping rules of DFDL such that a user can quickly tell whether the value of a property is set locally on an object, and if not set locally, the user can obtain additional information where the value is set and traverse to a location at which the value is set.

DFDL has more than 300 properties. In an embodiment, a filtered physical properties table is used to display the applicable properties of a given object and the values of these properties. In this manner, the user does not need to scan through a large listing of properties, many of which do not apply for a given element or object. The displayed value may be set locally, or inherited from the type of the object, an in-scope format object, or a known default value. Within the properties view, an inheritance icon 414 is placed in the row of any properties whose values are obtained from the type of the object, a format object that is currently in scope, or a known value. Any properties for which the value is set locally on the object do not have the inheritance icon displayed. If the user hovers a mouse over the inheritance icon 414 or property value, a pop-up dialog appears that describes where the value is defined and if applicable provides a link that the user can click on to traverse to a location in which the value is set. An example pop-up dialog for an inheritance icon may read, e.g., “Property inherited from global named format {http://www.ibm.com/dfdl/CommaSeparatedFormat}CommaSeparatedFormat.” This information may be stored in the storage device 104 or other storage location.

The properties view shown in editor pane 310 also may also provide a facility to specify sample test data for each simple element which is used while creating logical instance data from the message model.

Once the processes described in steps 202-206 have been completed, the user may then test the newly-created message model within the same user interface screen 300 to verify whether the DFDL schema is correct. At step 208, the editor module 120 receives a user-selected root from the editor pane 310. For example, as shown in FIG. 4, the user has selected an element 410 from the editor pane 310. The editor pane 310 and its contents are linked by the logic 108 to a pane 320 (FIG. 3) and its content via the parser module 122.

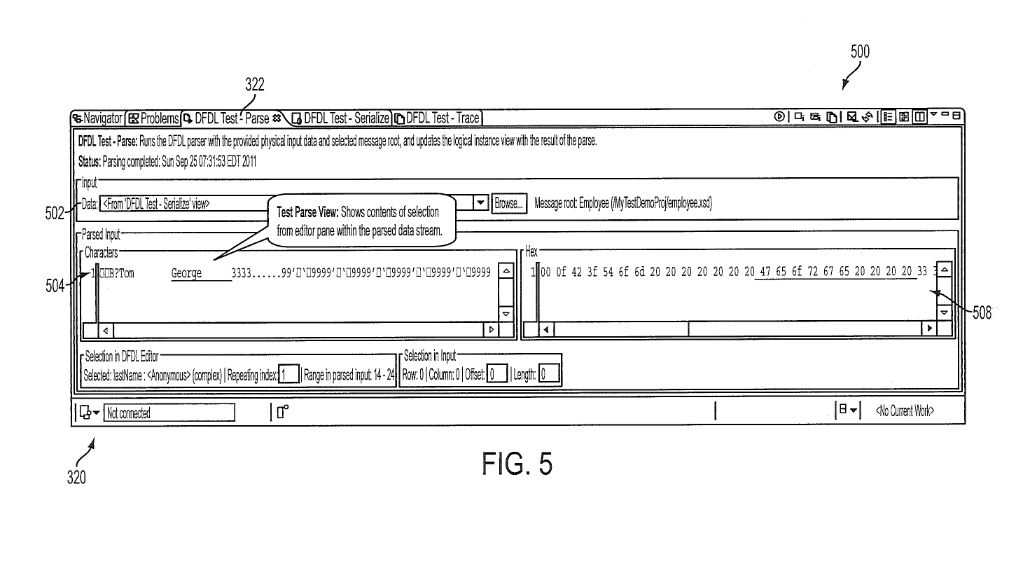

The pane 320 includes tabs 322, 324, and 326 that provide selectable stacked views, which include a parser view (from tab 322), a serialize view (from tab 324), and a trace view (from tab 326) for the message model indicated in the editor pane 310. At step 208, the parser module 122 receives an input data stream to be parsed within the pane 320, as shown, for example, in a pane 500 of FIG. 5. It will be understood that the pane 500 of FIG. 5 corresponds to the pane 320 once the parser tab 322 is selected. Thus, to initiate a parsing function, the user selects the appropriate root (e.g., element 410) from the editor pane 310, enters an input data stream in a field 502 in the pane 500/320, and the parser module 122 initiates a DFDL parsing function with the provided input data and selected element.

At step 210, the parser module 122 parses the input data stream against the message model using the DFDL schema, and the resulting parsed data is displayed in the pane 500/320 at step 212. As shown in FIG. 5, the parsed input may be provided to the user in character form (shown at 504), as well as in hexadecimal form (shown at 508). The character form shows the contents of the selection (i.e., “George”) from the editor pane 310 within the parsed data stream 504. When working with binary data, the user may need to see both the text and the hexadecimal parse view because some of the characters in the text view may not be printable. Thus, the parse view in pane 500/320 illustrates both forms of the parsed data.

For all elements in the editor pane 310 that have been parsed, the user can highlight any of the elements (e.g., 410) and the resulting parsed data will be retrieved from the corresponding linked databases by the logic 108 and displayed in the pane 320/500.

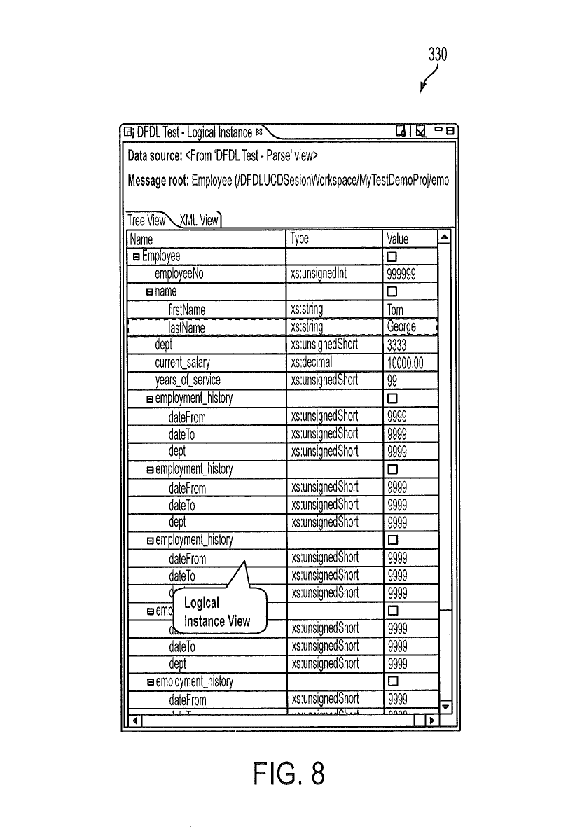

The parser module 122 also automatically populates a logical instance view in a logical instance pane 330 of the user interface screen 300. Again, this information can be viewed simultaneous with the message model (logical structure and physical properties) in pane 310. Sample logical instance data is shown in FIG. 8. The logical instance view data is an XML version of the message model and is presented in a logical tree structure. The logical instance view can also be created without an instance document by selecting an option 416 “Create Logical Instance” from the pane 310 (FIG. 4).

Turning back to FIG. 2, once the parsing has been completed, the user may use various techniques to identify whether any errors occurred during the parsing. A trace view may be created by the trace module 126 and populated with trace events emitted while parsing the physical stream.

If no errors are discovered as a result of the parsing at step 214, the user may continue to edit and/or test the message model (e.g., the user may identify and select another input data stream for processing) at step 216, and the process returns to step 210.

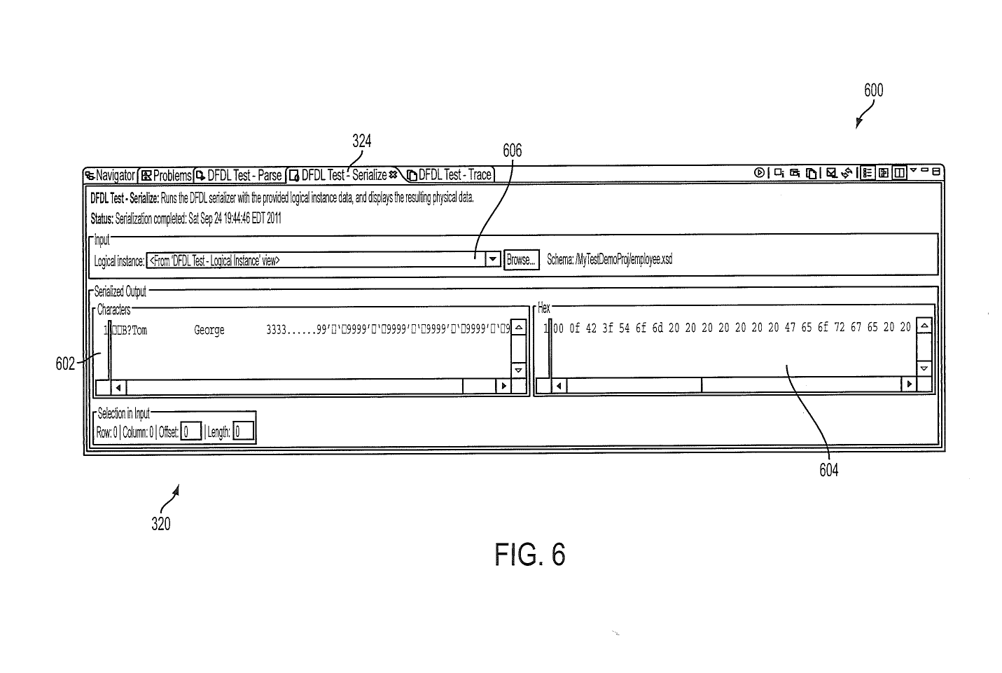

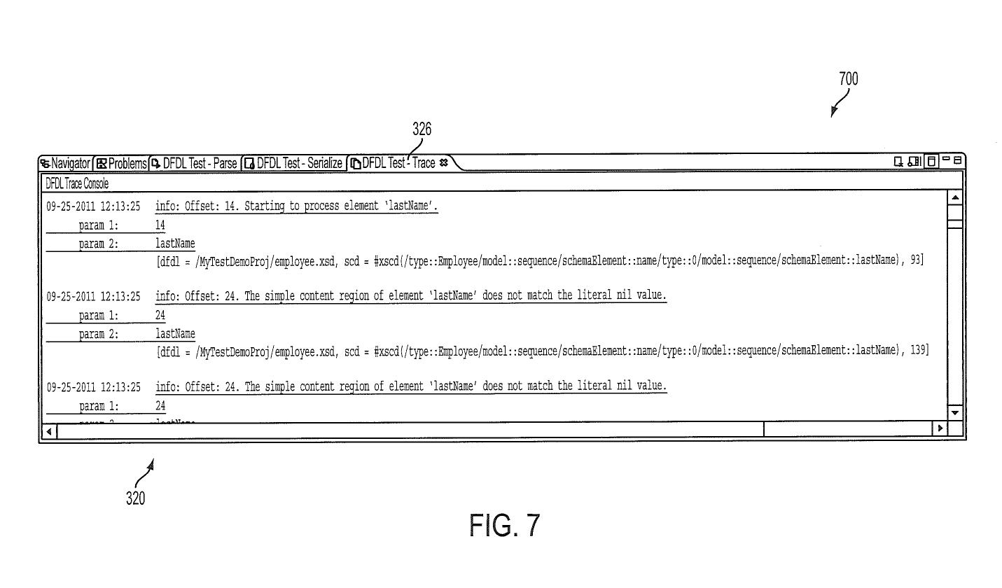

Alternatively, if no errors are discovered as a result of the parsing at step 214, the user may perform a test serialization at step 222. The serialize module 124 is configured to serialize selected logical views. As shown in FIG. 6, the pane 600 displays a serialized view in a character format (602) and in hexadecimal format (604) based on the selected logical view in input field 606. The pane 600 corresponds to the pane 320 once the user selects the serialize tab 324. Likewise, as shown in FIG. 7, a pane 700 displays a trace view that is created by the trace module 126 and is populated with trace events emitted while serializing the logical instance data. The trace events may contain errors, warnings, or information messages useful for debugging. These messages may contain a schema component designator (SCD) path. Clicking on the SCD path takes the user to the selection in the editor pane 310 which selects the corresponding region of the data in the parse view and the logical instance view. This gives the user a clear view of the error from different aspects. If the test serialization results in no errors at step 224, the process returns to step 216. Otherwise, the process continues to step 218 as described herein.

If an error has been detected at step 214 or at step 224, the error may be displayed as a selectable link to logical and/or physical properties for analysis at step 218. The parse view and/or serialize view may show the location of the error in the data and a hyperlink that opens the trace view for the user. If the DFDL schema is determined to be accurate and complete, the user may deploy the DFDL schema. At step 220, the user corrects the error in the message model, and the process returns to step 210.

Technical effects of the interactive development and testing of message models provide an interactive development, test, and debug of messaging models for non-XML data using a standards-based modeling language for non-XML data (e.g., binary data, text data, or a combination thereof), such as Data Format Description Language (DFDL). The exemplary interactive development and testing of message models provides a facility to describe a logical structure of data and its physical representation (DFDL) properties, a parser to parse a physical stream of data to create a logical model, a serializer to render the logical structure to the physical stream, and a set of interlinked views to enable a user to quickly visualize and analyze the model and the parsed/serialized data from different aspects.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method, comprising:
receiving, by an editor module executing on a computer processor, elements within a first side of an editor pane via a user interface, the elements defining a logical structure of data for a message model;
displaying, by the editor module, a listing of physical properties applicable to the elements in a second side of the editor pane;
providing a movable bar between the first side of the editor pane and the second side of the editor pane, the movable bar enabling extended views of a selected one of the first side and the second side of the editor pane;
receiving, by the editor module, a property from the listing of physical properties and associating the physical property with a corresponding one of the elements, such that selection of the element on the first side of the editor pane causes the property associated with the element to be displayed on the second side of the editor pane; and
creating the message model from received elements and associated physical properties.

2. The method of claim 1, wherein the elements represent at least one of binary data, text data, and a combination of binary data and text data, and the physical properties are defined using a standards-based modeling language.

3. The method of claim 1, wherein the physical properties are displayed in a tree structure.

4. The method of claim 1, wherein the user interface further includes a parser pane proximally located in a computer screen window with the editor pane, such that content in the parser pane and content in the editor pane are simultaneously viewable by an end user.

5. The method of claim 4, wherein the content in the editor pane is linked to the content in the parser pane.

6. The method of claim 4, further comprising:
receiving, via the editor module responsive to selection by the end user from the editor pane, one of the elements of the logical structure;
receiving, by a parser module, a data stream input by the end user in the parser pane;
parsing, by the parser module, the data stream against the message model; and
displaying results of the parsing in the parser pane.

7. The method of claim 6, wherein user interface further includes a logical instance view pane proximally located in the computer screen window with the editor pane, such that content in the logical instance view pane and the content in the editor pane are simultaneously viewable by the end user, wherein the method further includes:
displaying the results of the parsing in the logical instance view pane.

8. The method of claim 7, wherein the user interface further includes a serialize pane proximally located in the computer screen window with the editor pane, such that content in the serialize pane and the content in the editor pane are simultaneously viewable by an end user, the method further including:
serializing data in the logical instance view pane, once selected by the end user; and
displaying results of the serializing in both character format and hexadecimal format.
